(19) United States
(12) Patent Application Publication
(10) Pub. No.: US 2024/0236849 A1
(43) Pub. Date: Jul. 11, 2024

(54) METHODS, DEVICES, AND SYSTEMS FOR TRANSMITTING AND RECEIVING SIGNAL FOR POWER MANAGEMENT

(71) Applicant: ZTE Corporation, Shenzhen (CN)

(72) Inventors: Xuan MA, Shenzhen (CN); Mengzhu CHEN, Shenzhen (CN); Jun XU, Shenzhen (CN); Focai PENG, Shenzhen (CN)

(73) Assignee: ZTE Corporation, Shenzhen (CN)

(21) Appl. No.: 18/616,628

(22) Filed: Mar. 26, 2024

Related U.S. Application Data
(63) Continuation of application No. PCT/CN2021/131676, filed on Nov. 19, 2021.

(51) Int. Cl. H04W 52/02

(52) U.S. Cl. CPC H04W 52/0206

(57) ABSTRACT

The present disclosure describes methods, system, and devices for transmitting and receiving signal for power management. One method includes transmitting, by a user equipment (UE) to a base station, a message comprising first information corresponding to the base station switching between a first power state and a second power state; and receiving, by the UE from the base station, a response corresponding to the message, the response comprising second information. Another method includes receiving, by a base station from a UE, a message comprising a first information corresponding to the base station switching between a first power state and a second power state; performing, by the base station, a state transition operation switching between the first power state and the second power state; and transmitting, by the base station, a response comprising a second information.

### TECHNICAL FIELD

The present disclosure is directed generally to wireless communications. Particularly, the present disclosure relates to methods, devices, and systems for transmitting and receiving signal for power management.

### BACKGROUND

Wireless communication technologies are moving the world toward an increasingly connected and networked society. High-speed and low-latency wireless communications rely on efficient network resource management and allocation among one or more user equipment and one or more wireless access network nodes (including but not limited to base stations). A new generation network is expected to provide high speed, low latency and ultra-reliable communication capabilities and fulfill the requirements from different industries and users.

With the rapid evolution of cellular mobile communication systems, the power consumption of the new generation wireless base station has increased significantly. For example, compared with 4G base stations, the power consumption of 5G base stations is about a few times higher than that of 4G base stations due to the increased number of transmission/receive antennas, frequency band, etc. Improving the network energy efficiency is important to build a green and sustainable wireless communication system. However, some power saving schemes may have a number of problems/issues, for example, causing a large delay and affecting the user experience.

The present disclosure describes various embodiments for transmitting and receiving signal for power management, addressing at least one of the problems/issues discussed above. The various embodiments in the present disclosure may saving power and avoid affecting user experience, improving a technology field in the wireless communication.

### SUMMARY

This document relates to methods, systems, and devices for wireless communication, and more specifically, for transmitting and receiving signal for power management.

In one embodiment, the present disclosure describes a method for wireless communication. The method includes transmitting, by a user equipment (UE) to a base station, an initial reference signal or a channel, wherein the initial reference signal or the channel is used for measurement or used to carry first information; and receiving, by the UE from the base station, a response corresponding to the initial reference signal or a channel, the response comprising second information.

In another embodiment, the present disclosure describes a method for wireless communication. The method includes receiving, by a base station from a user equipment (UE), an initial reference signal or a channel, wherein the initial reference signal or the channel is used for measurement or used to carry first information; performing, by the base station, at least one of measurement, power state transition or keeping on a current power state; and transmitting, by the base station, a response comprising second information.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4A shows a flow diagram of a method for wireless communication.

FIG. 4B shows a flow diagram of a method for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various methods and devices for transmitting and receiving signal for power management.

New generation (NG) mobile communication system are moving the world toward an increasingly connected and networked society. High-speed and low-latency wireless communications rely on efficient network resource management and allocation among one or more user equipment and one or more wireless access network nodes (including but not limited to wireless base stations). A new generation network is expected to provide high speed, low latency and ultra-reliable communication capabilities and fulfill the requirements from different industries and users.

With the rapid evolution of cellular mobile communication systems, a wireless base station or wireless network node is using more and more power. For example, compared with 4G base stations, the power consumption of 5G base stations is 3-4 times that of 4G base stations due to the increased number of transmission/receive antennas, frequency band, etc. Improving the network energy efficiency is important to build a green and sustainable wireless communication system.

To obtain the power saving gain, some implementations may configure that the network may de-active/close some components (e.g., cell, carrier, band, etc.) to enter into a sleep state or a less-power-consumed state. However, the semi-static wake-up scheme may cause a large delay and affect the user experience. Transmitting information to the network by UEs can help the base station to make better power saving decisions and adjust the states quickly. The present disclosure describes various methods and devices for transmitting and receiving signal for power management, providing a more flexible wake-up mechanism and ensures that the network and the UE have the same understanding of the power saving operations, avoiding affecting user experience.

In general, the power consumption of a communication system may be split into two parts: the dynamic part and the static part. In general, the dynamic part may be only consumed when data transmission/reception is ongoing, for example the power consumption caused by radio frequency (RF) unit, digital to analog converter (DAC), power amplifier (PA), and/or the antennas. The static part may be consumed all the time, even when the data transmission/reception is not on-going, for example the basic digital circuit access devices for waking up the equipment in sleep modes.

Switch to sleep mode or turn off some RF components when they are not needed are effective methods to reduce network power consumption. For example, if there is no UE access, the carrier may be deactivated. When the traffic load is low, the number of Tx/Rx antennas may be reduced. However, there are some problems with this energy saving method. First, there are some common signals and necessary transmissions in new radio (NR), for example the synchronization signal block (SSB), system information block (SIB), paging, and physical random access channel (PRACH) reception. Therefore, the network may not easily enter into the low power consumption state, e.g., the sleep mode. Secondly, even if the devices can enter sleep states, it is a problem to wake up the devices. If semi-static configuration is used, the devices may be awakened only after sleeping for a period of time. If there is service requirement while the device is in sleeping states, the service requirement may not be met because of the caused delay, so as to affect user experience.

In various embodiments, the network may be able to enter the low power consumption state as long as possible to reduce power consumption of communication systems; a more dynamic wake-up mechanism may be introduced to meet the flexible service requirements and minimize the impact on user experience; and/or one or more UE may be involved in this procedure to achieve better results. In addition, the network provides a response to the UE, notifying the UE of the operation, states, or configurations to make the network has a consensus with the UEs and minimize the impact on the UE.

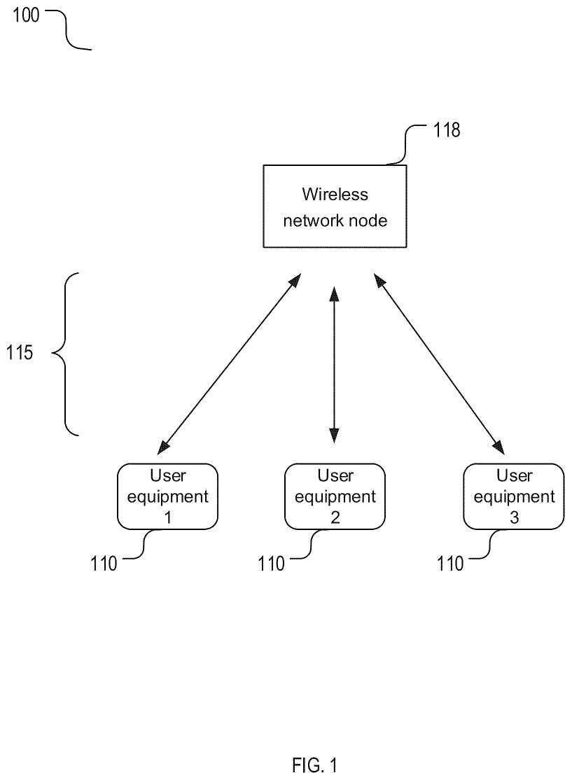

FIG. 1 shows a wireless communication system 100 including a wireless network node 118 and one or more user equipment (UE) 110. The wireless network node may include a network base station, which may be a nodeB (NB, e.g., a gNB, a eNB) in a mobile telecommunications context. Each of the UE may wirelessly communicate with the wireless network node via one or more radio channels 115. For example, a first UE 110 may wirelessly communicate with a wireless network node 118 via a channel including a plurality of radio channels during a certain period of time. The network base station 118 may send high layer signalling to the UE 110. The high layer signalling may include configuration information for communication between the UE and the base station. In one implementation, the high layer signalling may include a radio resource control (RRC) message.

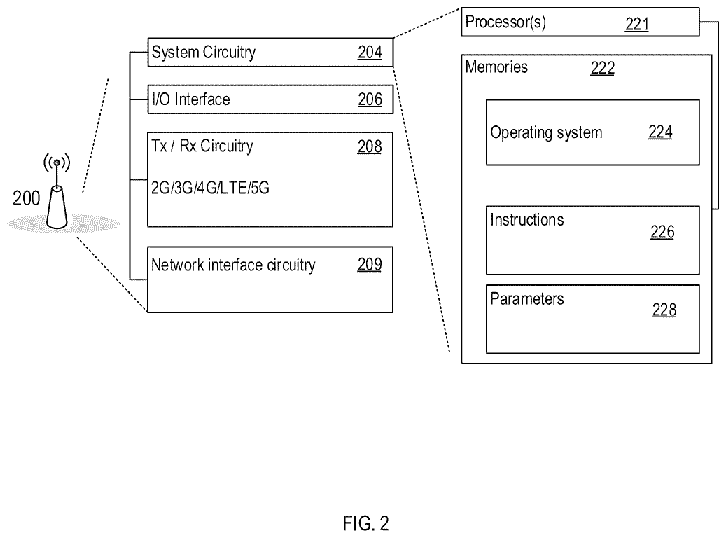

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

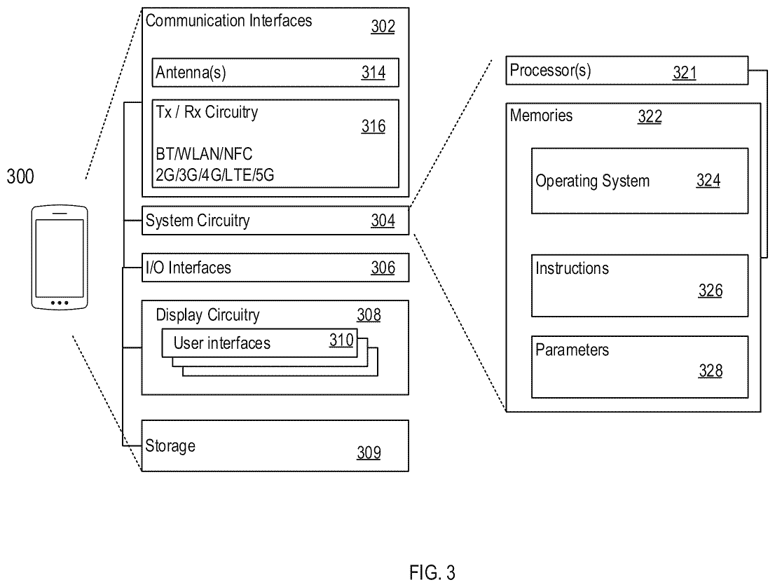

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPS)+, 4G/Long Term Evolution (LTE), 5G, and any further generation wireless communication standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

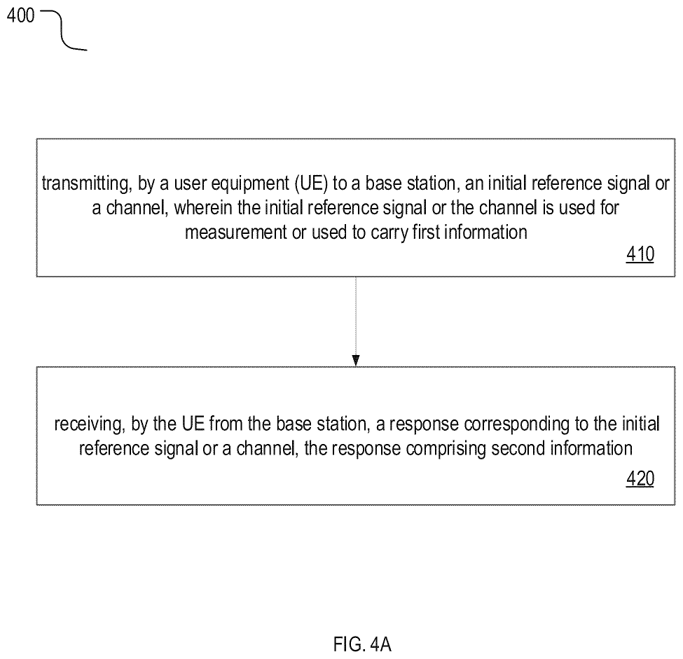

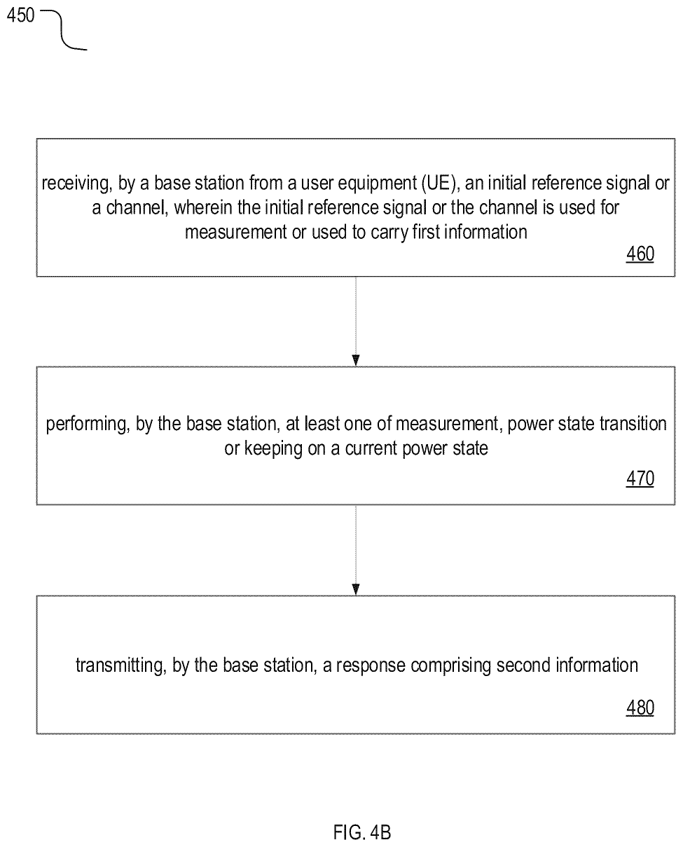

Referring to FIG. 4A, the present disclosure describes various embodiments of a method 400 for wireless communication. The method 400 may include a portion or all of the following steps: step 410, transmitting, by a user equipment (UE) to a base station, an initial reference signal or a channel, wherein the initial reference signal or the channel is used for measurement or used to carry first information; and/or step 420, receiving, by the UE from the base station, a response corresponding to the initial reference signal or the channel, the response comprising second information.

In some implementations, the initial reference signal or the channel is used for measurement, wherein the measurement comprise at least one of the following, the mobility measurement; the radio resource management (RRM); the coverage information; the channel or interference measurement; acquire the speed of UE; acquire the quality of reference signal or channel, wherein the quality of reference signal comprises at least one of the RSRP (reference signal received power), RSRQ (reference signal received quality), RSSI (reference signal state information), SINR (signal-to-noise and interference ratio), the L1-RSRP and L1-SINR of the reference signal or channel.

In some other implementations, the first information comprises at least one of the following: a indication which is used to indicate a power state; a power state transition indication; a wake up indication; a set of measurement results; or assistance information.

In some other implementations, the power state is one of a set of power states, wherein the power state is determined by at least one of the following: a higher layer configuration; or a UE capability.

In some other implementations, the different power states have different configurations.

In some other implementations, with a first condition, the base station transmit the response to the UE, wherein the first condition comprises at least one of the following: receiving the initial reference signal or the channel; a second power state being indicated by the initial reference signal or the channel; a second power state being determined by the initial reference signal or the channel; a measurement result satisfied a first condition; the measurement results carried by the initial reference signal or the channel satisfied the first condition; or the power state of base station is changed.

In some other implementations, the second information comprises at least one of the following: an acknowledgement/negative acknowledgement (ACK/NACK) indication; an indication of operation; a timing advance (TA) command; or a handover command.

In some other implementations, the UE sends the initial reference signal or the channel in a first cell; and the UE receives the response from the base station in the first cell or in a second cell.

In some other implementations, the UE receives the response from the base station in a reception window.

In some other implementations, the reception window is determined by at least one of the following: a start point; a duration; an end point; or a periodicity.

In some other implementations, at least one of the start point or the end point is determined by at least one of the following: a pre-determined transmission; a time location of a pre-determined transmission; an offset is in relative to a pre-determined transmission, wherein the pre-determined transmission comprise at least one of the following: a synchronization signal block (SSB), a secondary synchronization signal (SSS), a primary synchronization signal (PSS), a discovery burst, a tracking reference signal (TRS), a paging occasion (PO), a paging frame (PF), a DCI format 2_7, a downlink control information (DCI) format 2_6, or the message sent by the UE.

In some other implementations, the duration is determined by at least one of the following: a higher layer signaling, a UE capability, a subcarrier spacing (SCS), a frequency range, a fixed value, or a timer.

In some other implementations, an occurrence of the response is determined by at least one of the following: the first information sent by the UE; a measurement result of the initial reference signal or the channel sent by the UE; a UE capability; a higher layer signaling; an SCS; or a frequency range.

In some other implementations, the UE receives the response sent by the base station that is determined by at least one of the following: the first information sent by the UE; a periodicity; a channel quality or a maximum reception times.

In some other implementations, the UE receives the response from the base station in a frequency resource, wherein the frequency resource is determined by at least one of the following: a higher layer signaling; a start position in frequency domain; an end position in frequency domain; a number of resource blocks (RBs); an SSB; a CORSET 0; an active BWP; or an initial UL BWP.

In some other implementations, at least one of the start position or the end position in the frequency domain is defined in relative to at least one of the following: a common resource block #0; a point A; an SSB; a control resource set (CORESET) 0; an active bandwidth part (BWP); or the message sent by the UE.

In some other implementations, the response sent by the base station is carried by at least one of the following: a Message B based channel; a DCI; a sequence; or a higher layer signaling.

In some other implementations, the Message B based channel is related to at least one of the following: a time domain resource allocation; a frequency domain resource allocation; or a Message A based channel send by the UE.

In some other implementations, the DCI is a DCI with CRC scrambled by at least one of the following: a power saving-radio network temporary identifier (PS-RNTI); a paging-RNTI (P-RNTI); a system information-RNTI (SI-RNTI); a random access-RNTI (RA-RNTI); or a cell-RNTI (C-RNTI).

In some other implementations, the DCI includes an indication for at least one of the following: a paging early indication; a scheduling information of a paging message information; a scheduling information of system information; or a wake-up indication for the UE.

In some other implementations, the second information in the response sent by the base station is related to at least one of the following: a sequence generation; a DCI format; a time domain resource allocation; a frequency domain resource allocation; a higher layer configuration; or a scramble method.

In some other implementations, with a given condition, the UE continues to transmit the initial reference signal or the channel, wherein the given condition comprises at least one of the following: the UE not receiving any indication from the base station; the UE receiving a NACK indication from the base station; or the response from the base station being different from an indication by the UE.

In some other implementations, the continues transmission of the initial reference signal or the channel is related to at least one of the following: a timer after the UE first transmit the message; a pre-set condition; or a number of times that information is transmitted.

In some other implementations, the continues transmission of the initial reference signal or the channel is determined by at least one of the following: the timer expiring; the timer expiring and the pre-set condition being satisfied; the timer expiring, the pre-set condition being satisfied, and a number of transmission times of the message not exceeding a maximum transmission threshold; the pre-set condition being satisfied; or the pre-set condition being satisfied and a number of transmission times of the message not exceeding a maximum transmission threshold.

In some other implementations, the UE continues to transmit the initial reference signal or the channel with an increased power.

In some other implementations, the increased power is determined by at least one of the following: a higher layer parameter; a UE capability; a transmission times, a power in a previous transmission; or a delta value.

In some other implementations, the UE transmits the initial reference signal or the channel in a repetition manner.

In some other implementations, a number of repetition times is determined by at least one of the following: a higher layer parameter; a UE capability; a repetition number in a previous transmission; or a delta value.

In some other implementations, with a stated condition, the UE selects another cell, wherein the stated condition comprises at least one of the following: the UE not receiving any indication from the base station; the UE receiving a NACK indication from the base station; the response from the base station being different from an indication by the UE; or a transmission times of the message exceeding a maximum value.

Referring to FIG. 4B, the present disclosure describes various embodiments of a method 450 for wireless communication. The method 400 may include a portion or all of the following steps: step 460, receiving, by a base station from a user equipment (UE), an initial reference signal or a channel, wherein the initial reference signal or the channel is used for measurement or used to carry first information; step 470, performing, by the base station, at least one of measurement, power state transition or keeping on a current power state; and/or step 480, transmitting, by the base station, a response comprising second information.

In some implementations, the measure comprises at least one of the following: the mobility measurement; the radio resource management (RRM); the coverage information; the channel or interference measurement; acquire the speed of UE; acquire the quality of reference signal or channel, wherein the quality of reference signal comprises at least one of the RSRP (reference signal received power), RSRQ (reference signal received quality), RSSI (reference signal state information), SINR (signal-to-noise and interference ratio), the L1-RSRP and L1-SINR of the reference signal or channel.

In some other implementations, the first information comprises at least one of the following: a indication which is used to indicate a power state; a power state transition indication; a wake up indication; a set of measurement results; or assistance information.

In some other implementations, with a first condition, the base station transmit the response to the UE, wherein the first condition comprises at least one of the following: receiving the initial reference signal or the channel; a second power state being indicated by the initial reference signal or the channel; a second power state being determined by the initial reference signal or the channel; a measurement result satisfied a first condition; the measurement results carried by the initial reference signal or the channel satisfied the first condition; or the power state of base station is changed.

In some other implementations, the second information comprises at least one of the following: an ACK/NACK indication; an indication of operation; a timing advance (TA) command; or a handover command.

In some other implementations, the base station transmits the response in a set of transmission occasions or the base station transmits the response in a set of transmission occasions within a transmission window, wherein the transmission occasion is determined by at least one of the following: a start point; a duration; an end point; or a periodicity; or a search space configuration.

In some other implementations, the base station transmits the response is related to at least one of the following: the first information carried by the initial reference signal or the channel; a measurement result of the initial reference signal or the channel sent by the UE; a UE capability; a higher layer signaling; an SCS; or a frequency range.

In some other implementations, a frequency resource of the response by the base station is determined by at least one of the following: a higher layer signaling; a start position in frequency domain; an end position in frequency domain; a number of RBs; an SSB; a CORSET 0; an active BWP; or an initial UL BWP.

In some other implementations, the response sent by the base station is carried by at least one of the following: a Message B based channel; a DCI; a sequence; or a higher layer signaling.

In some other implementations, the second information in the response sent by the base station is related to at least one of the following: a sequence generation; a DCI format; a time domain resource allocation; a frequency domain resource allocation; a higher layer configuration; or a scramble method.

In various embodiment, a UE may transmit a initial channel and/or reference signal to a base station (gNB), wherein the initial channel and/or reference signal used for measurement or used to carries an initial information, and then, the UE may receive information carried by a data or/and reference signal from the base station (gNB). The present disclosure describes below examples for various embodiments. The below examples are for illustration purpose, and do not limit the scopes of the various embodiments.

### The First Information Transmitted by the UE

In some embodiments, UE transmit a initial channel or/and reference signal to base station, wherein the initial data and/or reference signal used for measurement or used to carries an initial information.

In some embodiments, the initial channel or/and reference signal is called the message.

In some embodiments, the initial reference signal and/or the channel is used for base station measurement. In some other embodiments, measurement comprise at least one of the following, the mobility measurement; the radio resource management (RRM); the coverage information; the channel or interference measurement; acquire the speed of UE; acquire the quality of reference signal or channel, wherein the quality of reference signal comprises at least one of the RSRP (reference signal received power), RSRQ (reference signal received quality), RSSI (reference signal state information), SINR (signal-to-noise and interference ratio), the L1-RSRP and L1-SINR of the reference signal or channel.

In some other embodiments, the initial reference signal and/or the channel carries a first information. In some embodiments, the first information comprises at least one of the following: a power state indication for the base station; a set of measurement results; or assistance information. In some other embodiments, the power state indication indicates one power state in a power state set. In some other embodiments, the power states in power state set can be divided into power saving state and non-power saving state. In some other embodiments, the power state set comprises at least one power saving state and at least one non-power saving state. In some other embodiments, the base station at different power state have different power consumption. In some other embodiments, the non-power saving state is called a first power state and the power saving state is called a second power state. In some embodiments, the power saving state is a fixed state with some fixed configuration. For example, the minimum cycle of reference signal transmission in power saving state is equal to 80 ms, the antenna port in power saving state is less than 2. In some embodiments, the power saving state is a relative state. For example, the power saving state can be a configuration, a working mode, or a configured state. For example, the power saving state is a relative lower power consumption state. The power saving state is relative to the highest configuration or current configuration of the element. For example, the elements have three states, state1, state2, and state3. Compared with state 1, state 2 and state 3 are both power saving states. Compared with state 2, state 3 is power saving state.

In some embodiments, the element in this disclosure comprises at least one of the following: Cell, frequency layer, band, carrier, TRP (Transmission and Receive Point), beam, TCI (Transmission Configuration Indication) state, antenna, antenna port, MIMO layer, rank, antenna panel, reference signal, or reference resource.

### Content/Functionalities in the Information UE Received

In some implementations, in response to a pre-set condition, the UE may receive the information sent from the gNB (the base station). The pre-set conditions comprise at least one of the following: receiving the initial reference signal or the channel; a second power state being indicated by the initial reference signal or the channel; a second power state being determined by the initial reference signal or the channel; a measurement result satisfied a pre-set condition; the measurement results carried by the initial reference signal or the channel satisfied the pre-set condition; or the power state of base station is changed.

In some embodiments, after receiving the initial data or/and reference signal, the base station send the response to the UE no matter what the information is. In some other embodiments, whether the base station transmit the response is related to the first information UE transmitted. For example, when the second power state is indicated or determined by the first information UE transmitted, the base station send the response to the UE. In some other embodiments, a measurement results acquired by base station measurement or the measurement results carried by the initial data and/or reference signal satisfied a pre-set condition, the base station send the response to the UE. The pre-set condition comprise at least one of the following: at least one of the measurement results smaller than a threshold, at least one of the measurement results is within a range. In some other embodiments, a power state is determined by the measurement results acquired by base station measurement or the measurement results carried by the initial data and/or reference signal, the base station send the response to the UE. For example, when the second power state is determined by the measurement results acquired by base station measurement, the base station send the response to the UE. Or when the power state of the base station is changed, the base station send the response to the UE.

In some other embodiments, the information that the UE receives comprises at least one of the following: an ACK/NACK indication; an indication of operation; and/or the information for the elements; a timing advance (TA) command; and/or a handover command.

In some embodiments, the information that the UE receives comprises an ACK/NACK indication. The ACK implies that the gNB response to the information sent by the UE, and/or the NACK implies that the gNB doesn't response to the information sent by the UE. Or the ACK implies that the gNB received the information sent by the UE, and/or the NACK implies that the gNB doesn't received the information sent by the UE. Or the ACK implies that the gNB performing the operation indicated by the information sent by the UE, and/or the NACK implies that the gNB doesn't performing the operation indicated by the information sent by the UE.

In some embodiments, the information that the UE receives comprises an indication of operation. The indication of operation includes at least one of the following: a power state, for example the first power state, the second power state; wake-up operation; the information for the elements, for example the configuration of the elements.

In some other embodiments, UE receives the gNB response in at least one of the following: a first cell where the UE sends the information; or a second cell where the UE sends the information in a first cell.

By receiving a response from the gNB, the UE can keep the same understanding as the gNB, so that it can be handed over to a more reasonable configurations in a timely manner. This feature can minimize the impact on UE experience while reducing power consumption of the gNB.

Occasion of Information from Base Station

In some implementations, information sent by a base station (gNB) is monitored by a UE in a set of monitor occasions.

In some other implementations, information sent by a base station (gNB) is monitored by a UE in a set of monitoring occasions during a reception window.

In some embodiments, the monitoring occasions of the information sent by a base station (gNB) is determined by a reception window and a pre-determined search space.

In some other embodiments, the monitoring occasions or the reception window are determined by at least one of the following methods.

One method includes at least one of a start point, a duration, an end point. The start point or end point is determined by at least one of the following: the time location of the reference signal/data (carried the first information) transmitted by UE, for example, the symbol/slot/sub-frame/frame when the UE transmits the reference signal/data; and/or an offset.

In some other embodiments, the start point or end point is defined in relative to at least one of the following: an SSB, SSS, PSS, DRS, a TRS, a PO, a PEI, a DCI 2_6, the reference signal/data sent by the UE, and/or the first window associated with the reference signal/data sent by the UE.

In some other embodiments, the duration is determined by at least one of higher layer signaling, UE capability, SCS, frequency range, a pre-determined value, for example a fixed value, a timer.

Another method includes a periodicity. In some implementations, the transmission occasion of the information sent by the gNB is periodic.

Another method includes determining an occurrence of the response (information) transmitted by base station by at least one of the following: the indication/information sent by UE; measurement results of the reference signal sent by the UE; a UE capability; higher layer signaling; an SCS; and/or a frequency range.

For the indication/information sent by the UE, in some implementations, the response (information) may occur when the wake-up operation or non-power saving state (the first power state) is indicated or determined by the indication/information sent by the UE. In some other implementations, the response (information) may occur when the power saving state (the second power state) is indicated or determined by the indication/information sent by the UE.

For the indication/information sent by the UE, in some implementations, the indication/information send by the UE may include at least one of assistance information, mobility information, RRM measurement information, or coverage information. For example, the assistance information send by the UE indicates that the gNB need to wake up, then the gNB transmits the response such as the indication of operation, a TA command, a handover command.

For an example of the measurement results of the reference signal sent by the UE, in response to the measurement results of the reference signal being lower than a pre-determined value, the response (information) may occur, the gNB transmits the response such as the indication of operation, a TA command, a handover command.

For an example of higher layer signaling, whether the base station transmits the response is determined by at least the higher layer signaling.

In some other implementations, a UE monitors the response/information sent by the gNB with a given condition. The given condition is related to at least one of the following: the indication/information sent by the UE, a channel quality, a periodicity, a reception times, or a maximum reception times.

In some embodiments, the given condition is related to the indication/information sent by the UE. In some implementations, the indication/information sent by the UE may include state transmission, or wake-up indication. For example, the UE monitors the information sent by the gNB when the wake-up or non-power saving state related information is sent by the UE. In some embodiments, the UE monitors the information sent by the gNB when the power saving state related information is sent by the UE. In some other implementations, the indication information includes at least one of assistance information, mobility information, RRM measurement information, or coverage information. For example, the UE may send the RRM measurement information, the RSRP that the UE send to gNB is lower than a pre-set value, and the UE monitors the information sent by the gNB.

In some embodiments, the given condition is related to a channel quality. In some embodiments, the channel quality is determined by at least one of the RSRP (reference signal received power), RSRQ (reference signal received quality), RSSI (reference signal state information), SINR (signal-to-noise and interference ratio), the L1-RSRP and L1-SINR of a reference signal. In some embodiments, when at least one of the channel quality is within a range, the UE starts to detect the response.

In some other embodiments, the given condition is related to a periodicity. The UE periodically detects whether there is a response transmitted. In some other embodiments, the given condition is determined by the indication/information sent by the UE and a periodicity. When the first information transmitted by the UE meets the conditions, the UE starts to detect the response and periodically detects the response.

In some other embodiments, the given condition is related to a maximum reception times. Before the maximum number of reception times is reached, the UE monitors the response.

In some other implementations, a UE monitors the response/information sent by the gNB after transmitting the first information to the base station no matter what the information is transmitted by the UE.

### Frequency Resource of the Information Sent by Base Station

In some implementations, the frequency resource of information sent by the base station (gNB) may be determined by at least one of the following methods.

One method to determine the frequency resource of the information is according to a higher layer signaling.

Another method to determine the frequency resource of the information is according to a start and/or an end position in the frequency domain. The start/end position in the frequency domain is defined in relative to at least one of the following: a common resource block #0; a Point A; an SSB, for example, reference point being the lowest RB (RE) of the SSB; a CORESET 0, for example, a reference point is the lowest RB (RE) of the CORESET 0; an active BWP, for example, reference point being the lowest RB (RE) of the active BWP; and/or the reference signal/data sent by UE, for example, reference point being the determined by the frequency resource of the reference signal/data sent by the UE.

Another method to determine the frequency resource of the information is according to a number of RBs. The number of RB may be determined by a bitmap, or a configuration of RBs, for example a configuration of consecutive RBs.

Another method to determine the frequency resource of the information is according to at least one of an SSB, a CORSET 0, an active BWP, or an initial UL BWP. For example, UE may not transit the data/reference signal outside the frequency span of the SSB or CORESET or active BWP, or initial UL BWP.

### Spatial Information of the Response Sent by Base Station

In some other implementations, the spatial information of the data/reference signal is determined by at least one of the following: an SSB, a TRS, a PEI, a paging DCI, and/or the reference signal/data sent by the UE.

In some embodiments, the data/reference signal is transmitted with multiple beams or quasi-colocation (QCL) information with the same beam directions to the pre-determined downlink signal or channel. The pre-determined downlink signal or channel comprises at least one of the following: SSB, TRS, PEI, Paging DCI. In some embodiments, for each beam direction, the data/reference signal is transmitted with the identical beam direction of the pre-determined downlink signal or channel. In some embodiments, for each beam direction, the data/reference signal is transmitted with the identical content. In some embodiments, for each beam direction, the data/reference signal is transmitted with different scrambling code. In some embodiments, the scrambling code is associated with the pre-determined downlink signal or channel.

In some embodiments, the quasi-colocation (QCL) information of the data/reference signal is associated with the pre-determined downlink signal or channel.

In some embodiments, the beam direction or the quasi-colocation (QCL) information of the data/reference signal is associated with the reference signal/data sent by the UE. For example, the transmission resource of the reference signal/data sent by the UE is associated with the pre-determined downlink signal or channel. The data/reference signal transmitted by base station has the same beam direction or the quasi-colocation (QCL) information with the pre-determined downlink signal or channel associated with the transmission resource of the reference signal/data sent by the UE.

### Format of Information Transmitted by the Base Station

The information is carried by at least one of the following messages.

In some implementations, the information is carried by a Message B based channel. The message B based channel used for carry the above information transmitted by the base station and a typical message B used for initial access are distinguished by at least one of the following: time domain resource allocation; frequency domain resource allocation; a Message A or message A based channel send by the UE.

In some other implementations, the information transmitted by the base station is carried by a DCI. The DCI is a DCI with CRC scrambled by at least one of the following: PS-RNTI (power saving-radio network temporary identifier), P-RNTI (paging-radio network temporary identifier), SI-RNTI (system information-radio network temporary identifier), RA-RNTI (random access-radio network temporary identifier), C-RNTI (cell-radio network temporary identifier) or a dedicated RNTI.

In some other implementations, the response from base station is a bit field in DCI format 2_6. For example, the bit field carries the response is after the existing bit field of DCI format 2_6 in Rel-17, such as after the wake-up indication or after the SCell dormancy indication. For another example, the bit field carries the response is the existing bit field of DCI format 2_6 in Rel-17. The meaning of the bit field is redefined. In some other implementations, the response from base station is a bit field in DCI format 2_7. For example, the bit field carries the response is after the existing bit field of DCI format 27 in Rel-17, such as after the paging indication or after the TRS availability indication. For another example, the bit field carries the response is the existing bit field of DCI format 2_7 in Rel-17. The meaning of the bit field is redefined.

In some embodiments, the DCI format 2_6 or DCI format 2_7 with the response has difference with the DCI format 2_6 or DCI format 2_7 in Rel-17. The difference comprises at least one of the following: the RNTI, a flag bit or bit field in the DCI. For example, the DCI format 2_6 with ps-RNTI is used for wake-up indication and/or SCell dormancy indication for Rel-17 UEs, while the DCI format 2_6 with a new RNTI is used to carry the response. For another example, a flag bit or bit field is added in the DCI format 2_6. When the flag bit is bit ‘1’, it denotes that the DCI format 2_6 is used to carry the response, otherwise, it is used for wake-up indication and/or SCell dormancy indication for Rel-17 UEs. Or, when at least one of the bit field in DCI format 2_6 is satisfy the pre-set condition (for example, all zeros or all ones), the DCI format 2_6 is used to carry the response, otherwise, it is used for wake-up indication and/or SCell dormancy indication for Rel-17 UEs.

In some other embodiments, the DCI include information related to at least one of the following: a paging early indication, a scheduling information of paging message, a scheduling information of system information, a wake-up indication for the UE.

In some other implementations, the information is carried by a sequence, wherein the sequence is a PN sequence, for example, a CSI-RS based sequence, or an SSS based sequence.

In some other implementations, the information is carried by higher layer signaling, such as a MAC CE, or RRC signaling.

In some embodiments, the information carried by the reference signal/data is determined by the at least one of the following: a sequence generation scheme including at least sequence initialization; a format (e.g., a DCI format); a time domain resource allocation; a frequency domain resource allocation, a higher layer configuration, and/or a scramble method.

In some other embodiments, the functionalities of the reference signal/data is distinguished by at least one of the following: a sequence generation scheme including at least sequence initialization; a format (e.g., a DCI format); a time domain resource allocation; a frequency domain resource allocation, a higher layer configuration, and/or a scramble method.

UE's Response in Response of not Receiving Response from Base Station

In a pre-determined condition, the UE continues to transmit the reference signal/data with first information. In some implementations, the pre-determined condition includes at least one of the following: the UE doesn't receive any information from the base station, the UE receive a NACK indication from the base station, and/or the response of NW is not the same as the indication by the UE.

In some other implementations, the continued transmission of the reference signal or data by the UE includes one of following operation modes.

The UE may continue to transmit the data/reference signal if any single condition or any combination of two or more conditions are satisfied: (1) a timer expires, (2) the pre-set condition is fulfilled; and/or (3) the transmission times of the data/reference signal does not exceed a maximum transmission times. In some embodiments, the timer is started after the UE transmits the data/reference signal;

For example, the UE may continue to transmit the data/reference signal if the pre-determined condition is fulfilled.

For another example, the UE may continue to transmit the data/reference signal when the pre-set condition fulfilled and the transmission times of the data/reference signal does not exceed a maximum transmission times.

In some embodiment, the pre-set condition comprises at least one of the following: the UE not receiving any indication from the base station; the UE receiving a NACK indication from the base station; or the response from the base station being different from an indication by the UE.

In some other implementations, the continued reference signal or data is transmitted with increased power, and the increased power may be determined by at least one of the following: a higher layer parameter, for example, the transmission power for each transmission occasion is determined by higher layer signaling; a UE capability, for example, the UE capability includes at least capability of the maximum transmission power or the maximum number of MIMO layer/antenna; a transmission times, for example, when the transmission timers is larger than a threshold, the UE transmit the reference signal or channel with a increased power; a power used in the previous transmission; a delta value, for example, the transmission power in the continued transmission is determined by the power in the previous transmission plus or multiple the delta value, and/or the delta value is determined by at least one of the following: a higher layer parameter or UE capability.

In some other implementations, the continued reference signal or data is transmitted in a repetition manner, and repetition times may be determined by at least one of the following: a higher layer parameter, for example, the repetition times for each transmission occasion is determined by higher layer signaling; a UE capability, for example, the UE capability includes at least capability of the maximum number of repetition times or the maximum number of MIMO layer/antenna; repetition times in the previous transmission; a delta value, for example, the repetition times in the continued transmission is determined by the repetition times in the previous transmission plus or multiple the delta value, and/or the delta value is determined by at least one of the following: a higher layer parameter or a UE capability.

In some other implementations, at least one of the continued reference signals or data is transmitted within more than one slot.

In some other implementations, in a pre-determined condition, UE selects another cell, and the pre-determined condition includes at least one of the following: the UE doesn't receive any indication from the base station; the UE receive a NACK indication from the base station; the response of the base station is not the same as the indication by the UE; and/or the transmission times of reference signal/data exceed a maximum value.

In some other implementations the continued transmission of the reference signal or data may not be the same; and/or the information carried by the continued transmission of the reference signal or data may not be the same.

### Other Information on the Base Station Side

In various embodiments, a base station (e.g., gNB) may receive the information carried by a data or/and reference signal from the UE; and/or the gNB may perform the state (mode) transition operation according to at least one of the following,

The gNB may perform the state (mode) transition operation according to the network receiving X indication from UE to indicate a state (mode) transition, where X≥1 or X/N≥p. N is the number of UEs in one cell, p≤1, and/or X is the number of UEs in the same power consumption state.

The gNB may perform the state (mode) transition operation according to UE assistance information in the information. At least one of the UE assistance information fulfill at least one of the following condition: the mobility speed of the UE is lower than a threshold; the current service of UE is insensitive to the delay, that is, a large delay can be accepted; the data to be transmitted for the UE in the following periods is small; the UE expects to enter a low power consumption state (e.g., IDLE state, inactive state, dormancy state, and DRX-OFF); and/or the UE can obtain data/reference signal from other cell.

The gNB may perform the state (mode) transition operation according to a number of UEs (terminals) in one cell. In some embodiments, when the number of UEs in one cell is less than a threshold, the network will hand over the UEs to other cells and perform the state (mode) transition operation.

The gNB may perform the state (mode) transition operation according to a coverage of the cells. In some embodiments, when a cell can cover the areas of other cells (multiple cells can cover the same area), one or more cells with smaller coverage areas can perform the state (mode) transition operation. In some embodiments, when multiple cells can cover the same area, one or more cells with fewer UEs can be switch to the power saving state. In some embodiments, when multiple cells can cover the same area, the base station may determine to deactivate one or more cells with few UEs.

The gNB may perform the state (mode) transition operation according to a configuration of the UEs. In some embodiments, the UEs related to the elements are in power saving state (e.g. IDLE/Inactive state, dormancy state), the elements can switch to power saving state. In some embodiments, the UEs are configured as CA (Carrier Aggregation)/DC (Dual Connectivity), and the UE can obtain the needed information from one of the cells, the elements can switch to power saving state.

The gNB may perform the state (mode) transition operation according to a traffic type currently transmitted. In some embodiments, whether the element can perform the state (mode) transition operation is related to the traffic type currently transmitted. For example, for the services with small data transmission requirement and insensitive to delay, the elements can be switch to power saving state, for example, reduce the antenna/bandwidth/MIMO layer.

The gNB may perform the state (mode) transition operation according to a UE capability.

The gNB may perform the state (mode) transition operation according to at least one of a period, a timer and a duration is configured. The elements switch to power saving state periodically.

The gNB may perform the waking up operation according to at least one of the following.

The gNB receives X indication from UE to indicate the gNB to wake up, where X≥1 or X/N≥p. N is the number of UEs in one cell, p≤1, and/or X is the number of UEs in the same power consumption state.

The gNB may perform the waking up operation according to the gNB receiving the UE assistance information. At least one of the UE assistance fulfill at least one of the following conditions: the mobility speed of the UE is larger than a threshold; the current service of UE is sensitive to the delay, that is, a large delay may not be accepted; the data to be transmitted for the UE in the following periods is large; and/or the UE may not obtain data/reference signal from other cell.

The gNB may perform the waking up operation according to a number of UEs (terminals) in one cell is larger than a threshold, and/or the network will hand over the UEs to other cells and wake up the cell.

The gNB may perform the waking up operation according to a traffic type currently transmitted. For example, for the URLLC service, the requirement of time delay is high, and the gNB should transmit data as fast as possible. Therefore, the corresponding elements should be waked up.

The gNB may perform the waking up operation according to a UE capability.

The gNB may perform the waking up operation according to at least one of a period, a timer and a duration is configured to indicate gNB wake up.

In some embodiments, the base station changes the power state after receive the reference signal and/or data from UE. In some embodiments, after the base station changing the power state according to the reference signal and/or channel from UE, the base station does not change the power state until it receives the reference signal and/or channel from UE again. In some other embodiments, after the base station changing the power state according to the reference signal and/or channel from UE, the base station changes the power state after a duration or the base station changes the power state until a timer expires. In some other embodiments, the base station switch to previous power state after the duration end or timer expires. In some other embodiments, the base station switch to a default power state after the duration end or timer expires. In some embodiments, the default power state is configured by high layer parameters.

The present disclosure describes methods, apparatus, and computer-readable medium for wireless communication. The present disclosure addressed the issues with transmitting and receiving signal for power management. The methods, devices, and computer-readable medium described in the present disclosure may facilitate the performance of wireless communication by transmitting and receiving signal for power management, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting, by a user equipment (UE) to a base station, an initial reference signal or a channel, wherein the initial reference signal or the channel is used for measurement or used to carry first information, so that the base station is configured to perform at least one of measurement, power state transition or keeping on a current power state; and
receiving, by the UE from the base station, a response corresponding to the initial reference signal or a channel, the response comprising second information.

2. (canceled)

3. The method according to claim 1, wherein the initial reference signal or the channel is used to carry first information, wherein:
the first information comprises at least one of the following:
an indication which is used to indicate a power state;
a power state transition indication;
a wake-up indication
a set of measurement results; or
assistance information.

4. (canceled)

5. The method according to claim 1, wherein:
with a first condition, the base station transmit the response to the UE, wherein the first condition comprises at least one of the following:
receiving the initial reference signal or the channel;
a second power state being indicated by the initial reference signal or the channel;
a second power state being determined by the initial reference signal or the channel;
a measurement result satisfied a first condition;
the measurement results carried by the initial reference signal or the channel satisfied the first condition; or
the power state of base station is changed.

6. The method according to claim 1, wherein:
the second information comprises at least one of the following:
an acknowledgement/negative acknowledgement (ACK/NACK) indication;
an indication of operation;
a timing advance (TA) command; or
a handover command.

7. (canceled)

8. The method according to claim 1, wherein:
the UE monitors the response from the base station in a set of monitor occasions; or
the UE monitors the response from the base station in a set of monitor occasions within a reception window,
wherein location of the monitor occasions is determined by at least one of the following:
a start point:
a duration;
an end point;
a periodicity; or
a search space configuration.

9. (canceled)

10. (canceled)

11. (canceled)

12. The method according to claim 1, wherein:
an occurrence of the response is determined by at least one of the following:
the first information carried by the initial reference signal or the channel;
a measurement result of the initial reference signal or the channel sent by the UE;
a UE capability;
a higher layer signaling;
a SCS; or
a frequency range.

13. The method according to claim 1, wherein:
the UE receives the response sent by the base station that is determined by at least one of the following:
the first information sent by the UE;
a periodicity;
a channel quality or
a maximum reception times.

14. (canceled)

15. (canceled)

16. The method according to claim 1, wherein:
the response sent by the base station is carried by at least one of the following:
a Message B based channel;
a DCI;
a sequence; or
a higher layer signaling.

17-20. (canceled)

21. The method according to claim 1, wherein:
with a given condition, the UE continues to transmit the initial reference signal or the channel, wherein the given condition comprises at least one of the following:
the UE not receiving any indication from the base station;
the UE receiving a NACK indication from the base station; or
the response from the base station being different from an indication by the UE.

22-23. (canceled)

24. The method according to claim 21, wherein:
the UE continues to transmit the initial reference signal or the channel with an increased power, wherein the increased power is determined by at least one of the following:
a higher layer parameter;
a UE capability;
a transmission times;
a power in a previous transmission; or
a delta value.

25. (canceled)

26. (canceled)

27. A method for wireless communication, comprising.
receiving, by a base station from a user equipment (UE), an initial reference signal or a channel, wherein the initial reference signal or the channel is used for measurement or used to carry first information;
performing, by the base station, at least one of measurement, power state transition or keeping on a current power state; and
transmitting, by the base station, a response comprising second information.

28. (canceled)

29. The method according to claim 27, wherein the initial reference signal or the channel is used to carry first information, wherein:
the first information comprises at least one of the following:
an indication which is used to indicate a power state;
a power state transition indication;
a wake-up indication;
a set of measurement results; or
assistance information.

30. The method according to claim 27, wherein:
with a first condition, the base station transmit the response to the UE, wherein the first condition comprises at least one of the following:
receiving the initial reference signal or the channel;
a second power state being indicated by the initial reference signal or the channel;
a second power state being determined by the initial reference signal or the channel;
a measurement result satisfied a first condition;
the measurement results carried by the initial reference signal or the channel satisfied the first condition; or
the power state of base station is changed.

31. The method according to claim 27, wherein:
the second information comprises at least one of the following:
an ACK/NACK indication;
an indication of operation;
a timing advance (TA) command; or
a handover command.

32. The method according to claim 27, wherein:
the base station transmits the response in a set of transmission occasions or the base station transmits the response in a set of transmission occasions within a transmission window, wherein the transmission occasion is determined by at least one of the following:
a start point;
a duration;
an end point;
a periodicity; or
a search space configuration.

33. (canceled)

34. (canceled)

35. The method according to claim 27, wherein:
the response sent by the base station is carried by at least one of the following:
a Message B based channel;
a DCI;
a sequence; or
a higher layer signaling.

36. (canceled)

37. (canceled)

38. (canceled)

39. An apparatus comprising:
a memory storing instructions; and
a processor in communication with the memory, wherein, when the processor executes the instructions, the processor is configured to cause the apparatus to perform:
transmitting, to a base station, an initial reference signal or a channel, wherein the initial reference signal or the channel is used for measurement or used to carry first information, so that the base station is configured to perform at least one of measurement, power state transition or keeping on a current power state; and
receiving, from the base station, a response corresponding to the initial reference signal or a channel, the response comprising second information.

40. The apparatus according to claim 39, wherein the initial reference signal or the channel is used to carry first information, wherein:
the first information comprises at least one of the following:
an indication which is used to indicate a power state;
a power state transition indication;
a wake-up indication
a set of measurement results; or
assistance information.

41. A wireless communication node comprising:
a memory storing instructions; and
a processor in communication with the memory, wherein, when the processor executes the instructions, the processor is configured to cause the wireless communication node to perform:
receiving, from a user equipment (UE), an initial reference signal or a channel, wherein the initial reference signal or the channel is used for measurement or used to carry first information;
performing at least one of measurement, power state transition or keeping on a current power state; and
transmitting a response comprising second information.

42. The wireless communication node according to claim 41, wherein the initial reference signal or the channel is used to carry first information, wherein:
the first information comprises at least one of the following:
an indication which is used to indicate a power state;
a power state transition indication;
a wake-up indication;
a set of measurement results; or
assistance information.
